(19) United States
(12) Patent Application Publication
(10) Pub. No.: US 2014/0301838 A1
(43) Pub. Date: Oct. 9, 2014

(54) REPAIR OF A GAS TURBINE COMPONENT

(71) Applicants: ALAN LOVELACE, KINGWOOD, TX (US); AARON FROST, CYPRESS, TX (US)

(72) Inventors: ALAN LOVELACE, KINGWOOD, TX (US); AARON FROST, CYPRESS, TX (US)

(73) Assignees: AARON FROST, CYPRESS, TX (US); ALAN LOVELACE, KINGWOOD, TX (US)

(21) Appl. No.: 14/228,599

(22) Filed: Mar. 28, 2014

Related U.S. Application Data
(60) Provisional application No. 61/808,772, filed on Apr. 5, 2013.

(51) Int. Cl. B23P 6/04

(52) U.S. Cl. CPC B23P 6/045
USPC 415/208.2; 29/889.1

(57) ABSTRACT

A gas turbine component is provided having a repaired vane platform and rail region in which a portion of the vane rail having been damaged during operation is removed. A bar insert is rough machined and is secured within a groove in the rail. The bar insert and rail are finish machined to restore the platform and rail geometry to an original size and condition.

### CROSS-REFERENCE TO RELATED APPLICATIONS

This application claims priority to U.S. Provisional Patent Application Ser. No. 61/808,772, filed on Apr. 5, 2013.

### TECHNICAL FIELD

The present invention generally relates to a system and method for repairing a gas turbine engine component, such as a turbine vane. More specifically, improvements are disclosed for a process that will extend the useful life of a gas turbine component which has suffered extensive wear.

### BACKGROUND OF THE INVENTION

In a typical gas turbine engine used in a powerplant application, a multi-stage compressor compresses a supply of ambient air and increases the air pressure and temperature. The compressed air flows into one or more combustors, where fuel is added to the compressed air by one or more fuel nozzles to create a fuel/air mixture. The mixture is then ignited to produce hot combustion gases. The hot combustion gases exit the one or more combustors and enter a turbine, where the gases expand and drive a turbine, which is in turn coupled through a shaft to the compressor. The engine shaft can also be coupled to a shaft that drives a generator for generating electricity.

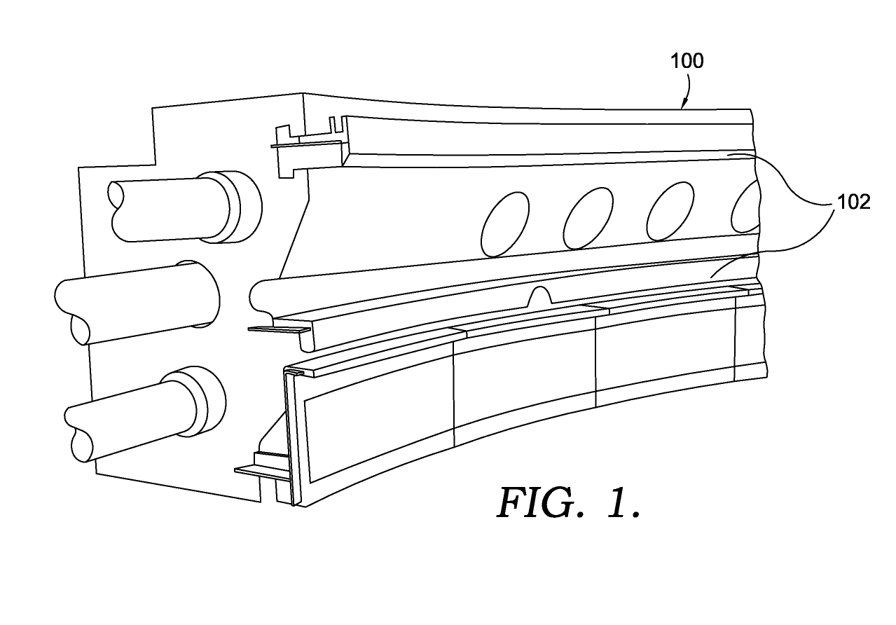

The compressor and turbine sections each include a plurality of blades fixed to stages of rotating disks. Spaced between each stage of rotating blades is a stage of stationary airfoils, also known as vanes. The vanes are secured within a compressor or turbine case. A portion of a typical engine case is shown in FIG. 1.

Typical gas turbine vanes have an airfoil for turning the compressor air or hot combustion gases to a desired incidence angle such that the flow is redirected towards the subsequent rotating stage of blades at the optimum orientation. A typical compressor vane has an airfoil extending radially inward from an outer platform, with the outer platform secured to the engine casing while a typical turbine vane has both an inner and an outer platform positioned at opposing ends of the airfoil. The platforms of the vanes are secured to the engine casing by one or more rails, or grooves cut into the platform sections. Due to aerodynamic load, mechanical wear and vibrations of the vanes, the vane platforms rub against the engine casing. Accordingly, these interface locations tend to wear and must be repaired or the entire vane replaced.

### SUMMARY

The present invention discloses a gas turbine engine component having a repaired platform/rail portion and a method for performing such a repair in order to extend the useful life of the gas turbine component.

In an embodiment of the invention, a gas turbine component, such as a compressor vane or turbine vane is provided having an airfoil secured to at least one platform. The platform includes at least one rail portion having a groove machined therein for receiving an insert. The insert is a separately machined bar of compatible material that is secured within the groove by brazing or other acceptable adhesion technique. The insert is then machined to a final desired shape and dimension such that the rail portion is in an operation-ready condition.

In an alternate embodiment of the present invention, a method of repairing a gas turbine engine component is disclosed. The repair method includes removing a damaged portion of the vane platform rail and removing an additional portion of material from the platform rail adjacent to the damaged portion in order to form a repair groove. One or more bar inserts are separately fabricated and sized to fit within the repair groove(s) of the vane platform rail. The one or more bar inserts are then secured within the repair groove, typically by a brazing process or other acceptable adhesion technique. Once the bar inserts are secured in place, the bar insert is then machined to the final desired shape or dimension.

It is an object of the present invention to provide a repaired gas turbine vane capable of continuing operation in a gas turbine engine, thereby allowing the vane to return to service instead of being discarded.

It is a further object of the present invention to provide a method of repairing a platform rail portion of a gas turbine vane so as to provide an engine operator with a repair procedure having a lower cost than replacing the vane.

Additional advantages and features of the present invention will be set forth in part in a description which follows, and in part will become apparent to those skilled in the art upon examination of the following, or may be learned from practice of the invention. The present invention will now be described with particular reference to the accompanying drawings.

BRIEF DESCRIPTION OF THE SEVERAL VIEWS OF THE DRAWINGS

The present invention is described in detail below with reference to the attached drawing figures, wherein:

FIG. 1 is a perspective view of a portion of a gas turbine engine case in which vanes of a gas turbine engine are located.

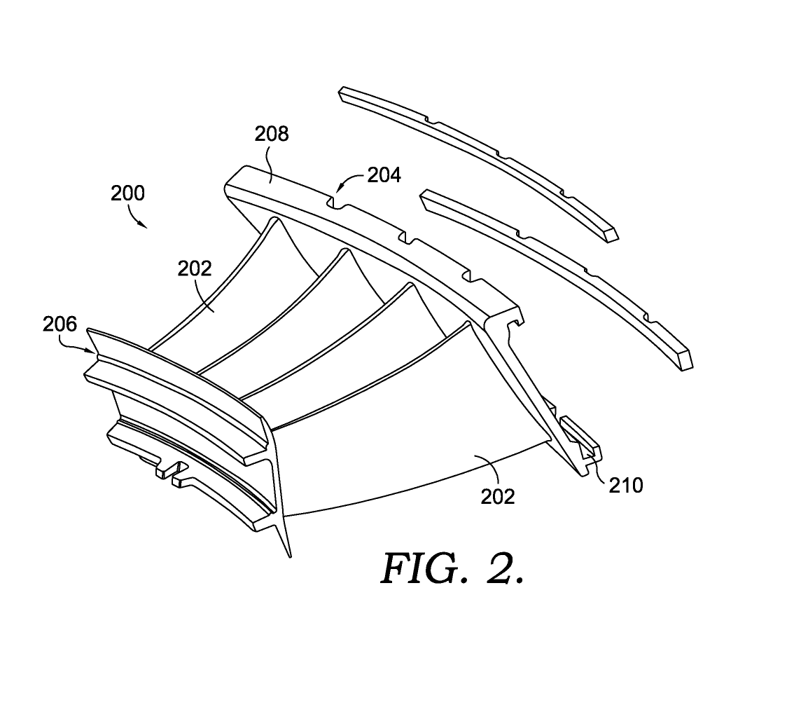

FIG. 2 is a perspective view of a gas turbine vane including bar inserts to be secured to the platform portions of the vane in accordance with an embodiment of the present invention.

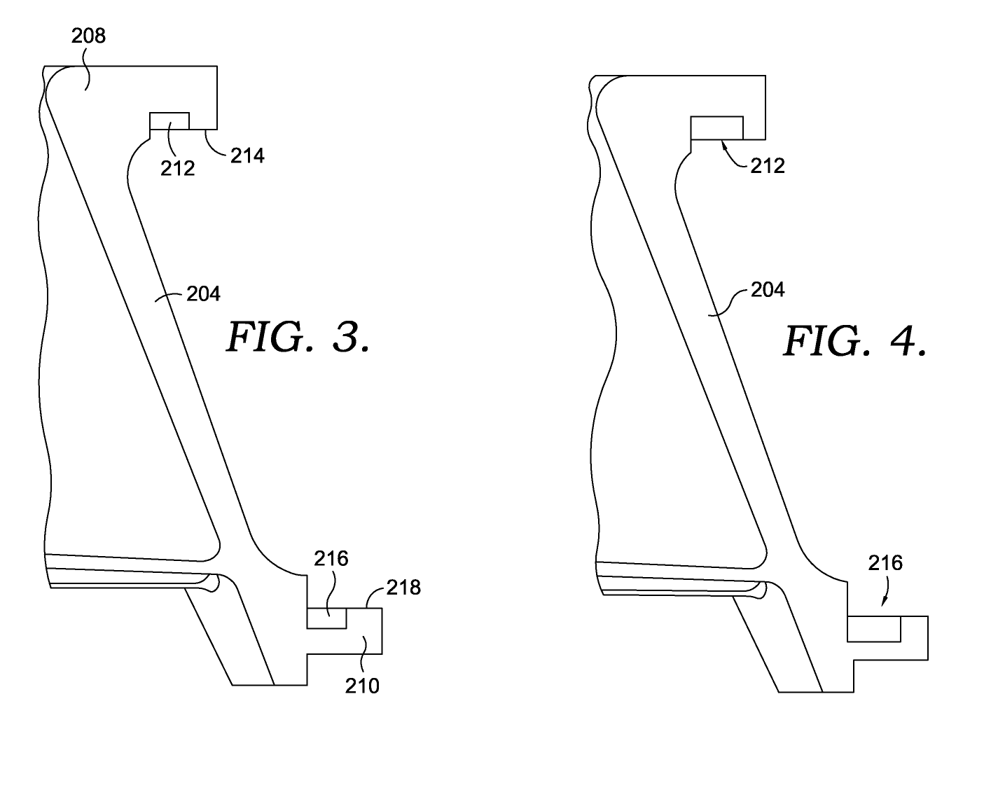

FIG. 3 is a cross section view of an outer platform portion of a gas turbine vane prior to repair.

FIG. 4 is a cross section view of an outer platform portion of a gas turbine vane undergoing a repair process in accordance with an embodiment of the present invention.

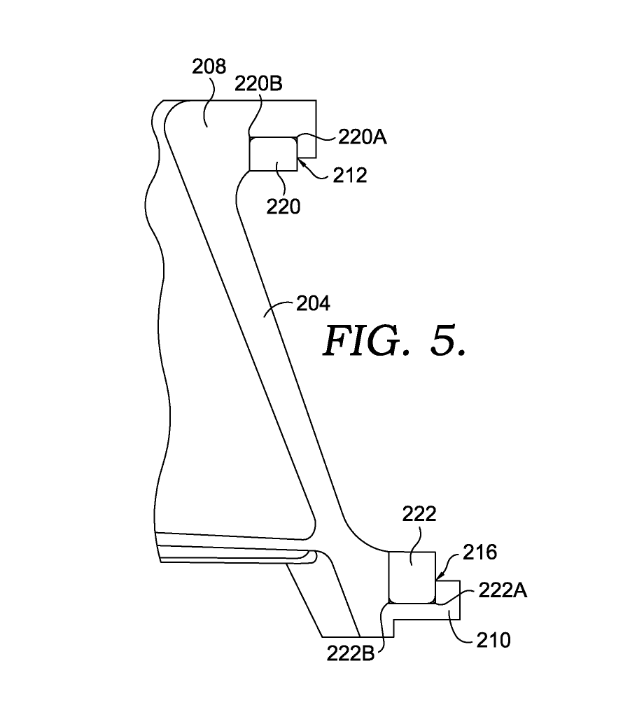

FIG. 5 is a cross section view of an outer platform portion of a gas turbine vane having the bar inserts placed in the outer vane rails in accordance with an embodiment of the present invention.

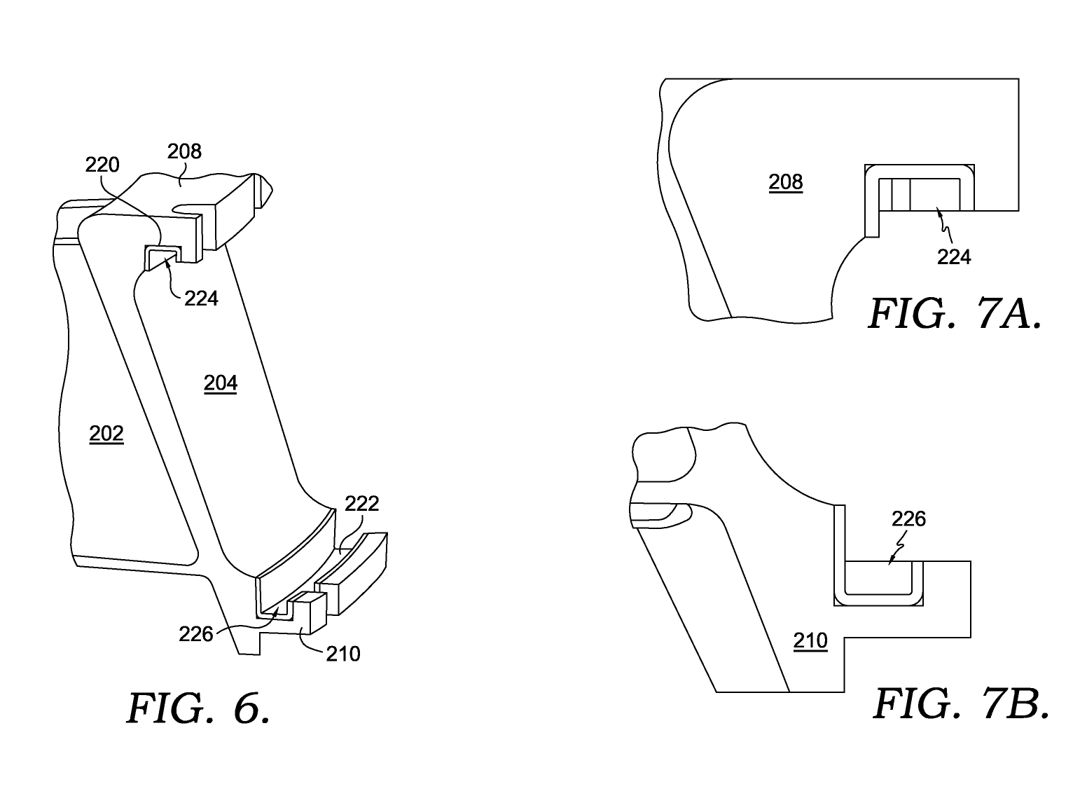

FIG. 6 is a perspective view of a portion of a gas turbine vane repaired in accordance with an embodiment of the present invention.

FIGS. 7A and 7B are cross section views of a portion of the gas turbine vane repaired in accordance with an embodiment of the present invention.

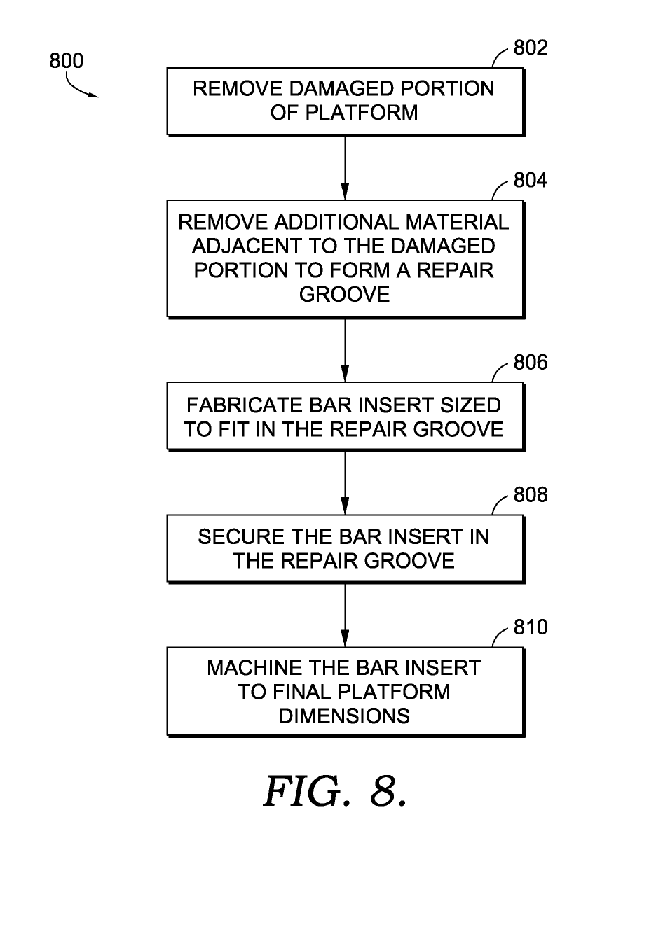

FIG. 8 is a flow diagram outlining the steps of a process to repair the gas turbine vane in accordance with an embodiment of the present invention.

### DETAILED DESCRIPTION

The preferred embodiment of the present invention will now be described in detail with specific reference to FIGS. 1-8. As discussed above, a compressor and/or turbine vane is secured within an engine casing. Referring now to FIG. 1, a portion of an engine casing 100 is shown in a partial perspective view. The engine casing 100 includes a plurality of tongues or tabs 102 for engaging in a corresponding groove of a vane (not shown) in a channel of the casing 100.

Referring now to FIG. 2, an embodiment of a turbine vane subject of the present invention is shown in perspective view. A gas turbine vane 200 typically comprises one or more airfoil portions 202 and an outer platform 204 extending radially outward from the airfoil 202 and extending circumferentially between adjacent airfoils 202, should multiple airfoils be present. Depending on the vane configuration, an inner platform 206 may also be present, where the inner platform 206 extends radially inward from the airfoil 202 towards an engine centerline, and circumferentially towards adjacent airfoils 202.

In an embodiment of the present invention a vane 200 for use in a gas turbine engine having repaired rails is disclosed. The vane 200 comprises an inner platform 206 and one or more airfoils 202 attached to the inner platform 206 and extending radially outward. An outer platform 204 is attached to the one or more airfoils 202, opposite of the inner platform 206, as shown in FIG. 2. Depending on the vane configuration, at least the outer platform 204 includes one or more rails. Specifically, as shown in FIGS. 2 and 3, the outer platform 204 includes a forward rail 208 and aft rail 210. With specific reference to FIG. 3, both the forward rail 208 and aft rail 210 have a groove machined therein, forming a hook-like configuration that is used to secure the vane to tabs 102 of the engine casing 100. More specifically, the forward rail 208 includes a groove 212 that has been machined into an aft face 214 of the forward rail 208 where the aft rail 210 includes a groove 216 that has been machined into the forward face 218 of the aft rail 210.

As discussed above, it is the grooves 212 and 216 and portions of associated rails 208 and 210 that wear as a result of vane installation and operation. In order to repair grooves 212 and 216 and rails 208 and 210 so as to restore these features to their original condition, the grooves 212 and 216 are enlarged, as depicted in FIG. 4, by machining a portion of parent rail material in rails 208 and 210. This is necessary in order to eliminate any additional minor damage that may be present, provide clean surfaces to accept the replacement material and provide a good contact surface for brazing or other means of securing.

Referring now to FIG. 5, a bar insert 220/222 of material compatible to that of the vane rail 208 and 210 is placed in the widened groove 212 and 216. It is desirable for the bar insert to be of compatible material (i.e. either the same material or other equivalent material) to the vane rail in order to obtain a complete and structurally sufficient bond between the insert and rail when the insert is bonded to the rail. For example, turbine vanes can be made of a variety of high temperature alloys, such as X45, which is a cobalt-based alloy. Therefore, it would be most desirable to fabricate the bar insert from the same alloy, or a compatible alloy such as L605, which is also a cobalt-based alloy.

As shown in FIG. 5, a first bar insert 220 is placed within the groove 212 in the forward rail 208 while a second bar insert 222 is placed within the groove 216 of the aft rail 210. The bar inserts are then secured within the grooves. The preferable process for securing the bar inserts 220 and 222 in place is brazing, but other means such as standard welding or electron beam welding may also be acceptable. To improve the braze joint, the interface between the grooves 212 and 216 and bar inserts 220 and 222 is important. The bar inserts 220 and 222 include chamfered or rounded corners 220A/220B and 222A/222B, as depicted in FIG. 5. These chamfered or rounded corners of the bar inserts 220 and 222 form relief areas between the inserts and grooves to ensure that the inserts do not contact the grooves. In order to ensure a satisfactory braze joint between the bar insert and groove, it is preferred that there exist a small gap of approximately 0.001 inches between the bar insert 220 and 222 and walls of the groove 212 and 216. For the example material discussed above, an acceptable braze alloy for bonding a bar insert fabricated from L605 to a rail of a vane fabricated from X45 would be a proprietary mixture of cobalt and/or nickel-based alloy powders. Such a mixture is placed between the bar insert and groove of the rail. The brazing cycle is then performed in accordance with generally accepted brazing techniques and procedures.

Referring now to FIGS. 6, 7A and 7B, the final configuration of a repaired vane platform 204 is shown in perspective and cross section views. More specifically, once the bar inserts are secured within the grooves of the vane rails, the bar inserts 220 and 222 are machined to their final required dimensions providing a necessary width and height to slots 224 and 226 such that the vane 200 will now properly engage the tabs 102 of the engine casing 100. For the embodiment shown in FIG. 7A, the machining of bar insert 220 in forward rail 208 results in a slot 224 having a generally U-shaped cross section. The final machining of the bar insert 222 in aft rail 210 results in a slot 226 having a generally J-shaped cross section. The size and shape of the slots in the rails 208 and 210 are merely representative of the particular embodiment described above and it is conceivable to have other shapes and sizes of slots in repaired vane rails.

In an alternate embodiment of the present invention, the vane 200 may only include an outer platform and not have a corresponding inner platform, such that the airfoil 202 extends radially inward from the outer platform 204. This type of vane configuration is commonly found in the compressor section of a gas turbine engine. In this alternate embodiment, the repaired rail sections discussed above would be applicable to only the outer platform region 204.

As discussed above, the size, shape, and orientation of the grooves in the vane rails and corresponding bar inserts can vary depending on the engine geometry. Therefore, while groove and insert geometries having generally “J-shaped” and “U-shaped” have been disclosed herein, it is to be understood that the geometries disclosed herein are merely representative, and not limiting.

Referring to FIG. 8, a method 800 of repairing a gas turbine engine component, such as a compressor or turbine vane, is disclosed. In a step 802, the damaged portion of the vane platform, such as a portion of the rail, is removed to form a repair groove. Then, in a step 804, additional material adjacent to the damaged area is removed. As discussed above, removing additional material adjacent the original slot is necessary in order to provide a clean and defect free area for bonding the insert to the slot/groove. In a step 806, a bar insert is fabricated and sized to fit within the groove created in steps 802 and 804. The fabrication of the bar insert can occur either in parallel with the formation of the groove or subsequent to the groove being formed in the engine component. In a step 808, the bar insert fabricated in step 806 is secured in the one or more grooves in the vane rails. Any number of securing methods may be used, but it is preferable to braze the bar insert into the groove in order to get the strongest and most complete joint between the mating parts. Then, in a step 810, the bar insert, which has been secured to the vane platform, is machined to its final dimensions such that the engine component can return to service. As discussed above, machining of the bar insert can be completed by a variety of processes such as grinding.

While the invention has been described in what is known as presently the preferred embodiment, it is to be understood that the invention is not to be limited to the disclosed embodiment but, on the contrary, is intended to cover various modifications and equivalent arrangements within the scope of the following claims. The present invention has been described in relation to particular embodiments, which are intended in all respects to be illustrative rather than restrictive. Alternative embodiments and required operations, such as the quantity and location of vane rails requiring repair and slot configuration, will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

1. A method of repairing a platform region of a gas turbine vane comprising:
removing a damaged portion of the vane platform;
removing additional material adjacent to the damaged portion, thereby creating one or more repair grooves;
fabricating one or more bar inserts sized to fit in the one or more repair grooves;
securing the one or more bar inserts in the one or more repair grooves; and
machining the one or more bar inserts and vane platforms to final platform dimensions.

2. The method of claim 1, wherein the one or more bar inserts are secured in the one or more repair grooves by a brazing process.

3. The method of claim 2, wherein the brazing process also provides a heat treat cycle for stress relieving the gas turbine vane.

4. The method of claim 1, wherein the removal of adjacent material forms a clean surface for brazing the one or more bar inserts.

5. The method of claim 4, wherein the bar insert further comprises includes at least one chamfered or rounded edge.

6. The method of claim 1, wherein the damaged portion is removed by a grinding process.

7. The method of claim 1, wherein the one or more repair grooves are located in an outer rail of an outer platform.

8. The method of claim 1, wherein the one or more repair grooves are located in both an outer rail of an outer platform and an inner rail of an inner platform.

9. A vane assembly comprising:
one or more airfoils;
a platform extending from to the one or more airfoils, the platform having at least one rail with a groove machined therein; and
a partially machined insert secured within the groove;
wherein the insert is sized so as to be final machined once secured within the groove of the rail.

10. The vane assembly of claim 9, wherein the vane assembly is a compressor vane or a turbine vane.

11. The vane assembly of claim 9, wherein the at least one rail comprises a forward rail and an aft rail extending radially from the vane platform.

12. The vane assembly of claim 9, wherein the insert is fabricated from a material comparable to that of the vane platform.

13. The vane assembly of claim 12, wherein the insert is brazed in the groove of the rail.

14. A repaired rail portion of a vane assembly comprising:
a platform coupled to one or more airfoils, the airfoils extending radially from the platform;
a forward rail having a forward face and an aft face, the forward rail extending outward from the platform; and
an aft rail having a forward face and an aft face, the aft rail extending outward from the platform;
wherein at least one of the forward rail and the aft rail has a groove therein in which a bar insert is placed, secured thereto, and machined to a final configuration.

15. The vane assembly of claim 14, wherein the bar insert is fabricated from a material that is compatible to a material of the platform.

16. The vane assembly of claim 14, wherein the one or more airfoils are integral with the platform.

17. The vane assembly of claim 14, wherein the bar insert is welded in the groove of at least one of the forward rail and the aft rail.

18. The vane assembly of claim 14, wherein the bar insert is brazed into the groove of at least one of the forward rail and the aft rail.

19. The vane assembly of claim 18, wherein the bar insert further comprises a chamfered edge or rounded edge.

20. The vane assembly of claim 14, wherein the groove in the forward rail is along the aft face of the forward rail and the groove in the aft rail is along the forward face of the aft rail.
